(19) United States
(12) Patent Application Publication
(10) Pub. No.: US 2001/0004302 A1
(43) Pub. Date: Jun. 21, 2001

(54) Optical unit and its use

(75) Inventors: Andreas Herren, Benglen (CH); Elisabetta Rugi, Dielsdorf (CH); Saverio Sanvido, Glattbrugg (CH); Jakob Neubert, Zuerich (CH); Christoph Haupt, Zuerich (CH)

Correspondence Address: TOWNSEND & TOWNSEND and CREW LLP, Two Embarcadero Center, 8th Floor, San Francisco, CA, 94111-3834, US

(73) Assignee: Contraves Space AG

(21) Appl. No.: 09/733,710

(22) Filed: Dec. 8, 2000

(30) Foreign Application Priority Data
Dec. 9, 1999 (CH) 2269/99

(51) Int. Cl. G02B 7/02

(52) U.S. Cl. 359/892; 359/811

(57) ABSTRACT

In a first variation, the novel optical unit (10) comprises several optical elements (14.1, 14.2, 14.3, 14.4, 14.5), and an integrally produced support structure (12) with element supports (16.1, 16.2, 16.3, 16.4, 16.5) for each of the optical elements (14.1, 14.2, 14.3, 14.4, 14.5). At least one of the element supports (16.1, 16.2, 16.3, 16.4, 16.5) is formed by a simply connected body, i.e. a linear support (16.4) or a plate (16.1, 16.2, 16.3, 16.5), or shell. The dimensions of this element support are matched to the optical element (14.1, 14.2, 14.3, 14.4, 14.5), wherein at least a portion of the element supports (16.1, 16.2, 16.3, 16.4, 16.5) is partially free along their rim. In a second variation the optical unit (10) comprises at least one optical element (14) and an integrally produced element support (16) made of the same material, preferably Zerodur®. The optical element (14) is preferably fastened directly on the element support (16) by gluing. The optical unit (10) having the characteristics of the first and/or second variation is suitable for use as a component of an apparatus intended for employment in space, wherein the receiving structure (12) is fastened on the apparatus at least approximately isostatically.

### FIELD OF THE INVENTION

The invention relates to an optical unit comprising several optical elements and a support structure with element supports for receiving the optical elements. The invention furthermore relates to the use of the optical unit.

### BACKGROUND OF THE INVENTION

Within the scope of the present specification, the term “optical unit” is intended to mean units with optical elements, such as mirrors and lenses, i.e. reflecting telescopes, for example, and in particular, but not exclusively, so-called skewed reflectors, i.e. reflector telescopes whose mirrors are not arranged coaxially.

Demands for accuracy made on optical units are generally comparatively great. Particular demands are made on optical units which are parts of apparatus used in space. These not only need to meet extensive requirements made on accuracy, but also compatibility requirements demanded in space, which makes achieving great accuracy difficult. In particular, the mass of the optical unit must be as low as possible. Moreover, the optical unit and its fastening on the apparatus must be embodied to be such that its transport into space, which usually takes place by means of a rocket and involves high static loads and vibrations, can be tolerated without damage. Finally, the optical unit and its fastening on the apparatus must be laid out in such a way that the large temperature differences occurring in space, and the steep temperature gradients caused by these temperature differences, have no negative effects on the apparatus and the optical unit. It is possible here for the extremes of temperature to lie far outside the range of customary ambient temperatures.

Up to now, essentially two types of optical units have been known for use in space. With the first type, the optical elements are coaxially arranged and the receiving structure is in the approximate shape of a tube, if necessary with branches, and the optical elements, i.e. the mirror or lens arrangements, are received in this tube, or are enclosed in a dynamically balanced manner by this tube, or the branches of the tube. With the second type, the optical elements are not coaxially arranged, the receiving structure essentially is in the shape of a closed box and the optical elements are fastened to surfaces of this box. The disadvantage of the tube-like, as well as the box-like receiving structures is essentially seen to lie in that they are too heavy. In general, they have a wall thickness which is the same all over and is designed for that element support, which is subjected to the greatest stress, as a result of which the receiving structure for the areas of other, less stressed element supports, is too large. Moreover, the tube-like, as well as the box-like receiving structures are disadvantageous in view of thermal stresses, since they essentially form a closed envelope.

A further disadvantage of the previously known optical units lies in that the optical elements and their element support have different rates of heat expansion, which has a negative effect on the precision of their position in respect to each other, as well as on the durability of their connection with each other.

### OBJECT AND SUMMARY OF THE INVENTION

It is therefore the object of the invention to

provide an optical unit of the type mentioned at the outset, by means of which the disadvantages of the prior art structures can be avoided,

propose an optical unit of the type mentioned at the outset, which avoids the problem of the differences in heat expansion between the structure and the optical elements, and

to propose a use of the novel optical units in space.

In accordance with the invention, this object is attained in accordance with the invention

for the optical unit by means of the characteristics of claim 1 or 6, and

for the use by means of the characteristics of claim 11.

Advantageous further developments of the optical unit are defined in dependent claims 2 to 5 and 7 to 10, and advantageous further developments of the use in dependent claim 12.

In the first embodiment variation, the novel optical unit has an integrally produced receiving structure having at least one element support, which is formed by a longitudinal support or a plate, or a shell, wherein this element support is unencumbered along a portion of its rim, or is fastened to other parts of the receiving structure, in particular other element supports, only along a portion of its rim. Further element supports can also be embodied in this novel shape, and a receiving structure made of such supports can be called an open receiving structure. Such a receiving structure in accordance with the invention is therefore an essentially open receiving structure, for example in the shape of a three-dimensional mass structure consisting of individual, mostly thin-walled, elongated or plate- or shell-like put-together element supports. Thus the optical unit does not have an enclosure. In this way it is possible to dimension every element support, and every structural part connecting the element supports, individually in respect to its size and its sturdiness in accordance with the optical element it receives. The wall thickness of plate-like element supports in particular can be matched to the thickness of the optical elements they are to receive.

As mentioned, the element support is fastened on other parts of the receiving structure only along a portion of its rim. This portion can be continuous, so that the element support is fastened in a cantilevered manner, so to speak, or it can consist of a few, for example two, partial areas.

Many advantages can be achieved by the novel embodiment of the receiving structure of the optical unit, and the most important ones of these will be listed in what follows.

Essentially, material is only employed where it is actually needed for reasons of the dimensions of the optical elements. By means of this it is possible to decrease the mass of the receiving structure, and the energy requirements for transporting the apparatus to which the optical unit is attached is thus reduced.

Because of the embodiment of the receiving structure, or the lack of an envelope for the optical unit, their moments of inertia are also reduced, which has the result that the output requirements for tracking by the optical unit are also minimized. If, on the other hand, a defined amount of energy for tracking by the optical unit is provided, the bandwidth of the tracking can be increased, for example.

Moreover, disadvantageous effects of the large temperature differences and temperature gradients can be eliminated or at least reduced to a large degree by means of the low-mass and open design of the receiving structure.

Additional element supports can then be embodied similar to the known receiving structures as closed element supports in a tube- or box-shape. Such receiving structures can then be called complex receiving structures.

The element supports are preferably dimensioned not only to match the dimensions and masses of the optical element to be received, but generally to match the stresses to be absorbed, in order to minimize the mass and moments of inertia of the support structure as much as possible.

It has been shown to be practical for this purpose to provide the individual element supports with mass-reducing cutouts, for example bores, and/or with reinforcing attachments, for example ribs, possibly also with beads for increasing stiffness.

To avoid problems of different heat expansion it is advantageous to make the element supports and the optical elements fastened thereon from materials with at least approximately the same coefficient of heat expansion.

The element supports of the novel optical unit can be produced individually and connected with each other by screwing, bolting, riveting, gluing, welding or soldering them together.

In another preferred embodiment of the novel optical unit the receiving structure can be integrally produced, for example, pressed, molded, sintered, cut out of a block, or produced from bent and, if required, deep-drawn plate material.

In the second embodiment variation of the invention, the novel optical units are produced with element supports and optical elements made of the same material.

A material of the type of the glass-ceramic material “Zerodur”®, for example, has been shown to be a very suitable material.

Every optical element can be fastened directly in the associated element support, for example by cementing or gluing of its element rim to the rim of a recess in the element support intended for receiving the element.

The optical elements must be precisely positioned in the element support in order to achieve the required precision. This can take place by means of cooperating fitting surfaces and/or by spacers arranged between the optical elements and the element supports.

The characteristics of the first and second embodiment variation of the invention can be combined, from which an optical unit results which in every way is particularly advantageous in mechanical and thermal respects.

Although the optical units in accordance with the invention had been specially conceived for use in space, they can also be employed in other ways. When using the optical units as components of an apparatus in space, the receiving structure is advantageously fastened at least nearly isostatically on the apparatus.

Further properties and advantages of the invention will be extensively described in what follows by means of the description and with reference to the drawings.

### BRIEF DESCRIPTION OF THE DRAWINGS

FIG. 1 is a diagram of a first optical unit in accordance with the invention,

FIG. 2 shows a second optical unit in accordance with the invention in the same representation as in FIG. 1,

FIG. 3 shows a second optical unit in accordance with the invention in the same representation as in FIG. 1 and FIG. 2,

FIG. 4 is a sectional view of a first embodiment of an optical element fastened in an element support,

FIG. 5 also is a sectional view of a second embodiment of an optical element fastened in an element support, and

FIG. 5A shows a detail from FIG. 5.

### DETAILED DESCRIPTION OF THE PREFERRED EMBODIMENTS

FIG. 1 represents a first optical unit 10, whose receiving structure 12 has a very low mass. The optical unit 10 contains five optical elements 14.1, 14.2, 14.3, 14.4, 14.5. Each optical element 14.1 to 14.5 is fastened in an element support 16.1, or 16.2, or 16.3, or 16.4, or 16.5. The three element supports 16.1, 16.2 and 16.3 are constituted by plates connected with each other, or by an appropriately bent plate, wherein the element support 16.2 is connected by one of its rim edges 18.1 with the element support 16.1, and at the oppositely located rim edge 18.2 with the element support 16.3. The element support 16.3 is connected with the element support 16.4 at the rim edge 18.3 located opposite the rim edge 18.2. On its outer end, the element support 16.4 has an end element 17.4 oriented transversely to its longitudinal direction, in which the optical element 14.4 is received. The element support 16.5 is connected along the rim edge 18.4 with the element support 16.2. All remaining rim edges of the element supports 16.1 to 16.5 are free. The element support 14.4 has several mass-reducing cutouts 19. The receiving structure 12 of this optical unit 10 is open and produced in ultralight construction. The plate(s) can be provided with beads for increasing the flexural strength.

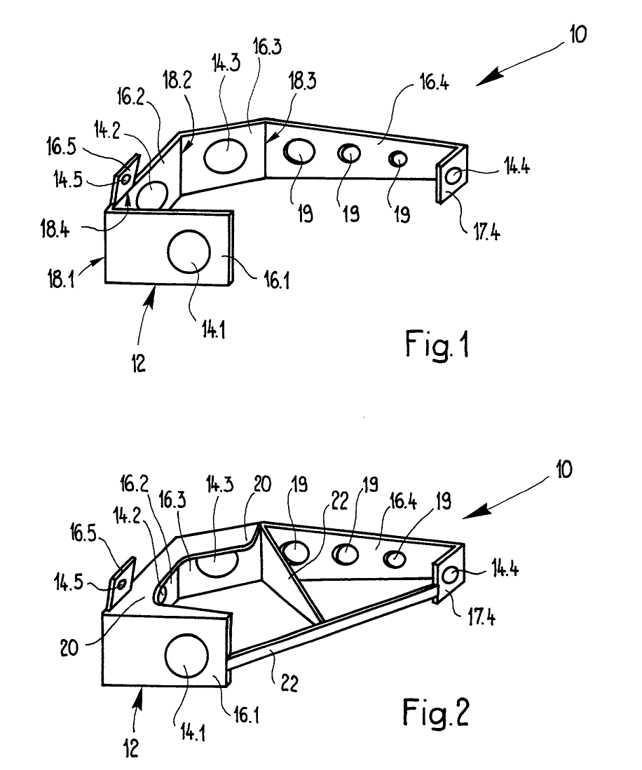

A further optical unit 10 is represented in FIG. 2, which has the same optical elements 14.1 to 14.5 as the optical unit represented in FIG. 1. But here the receiving structure 12 is more resistant to deformations of the individual element supports 14.1 to 14.3, or twisting of the entire receiving structure 12, thanks to reinforcement ribs 20 on the element supports 16.1 to 16.3, and thanks to additional stiffening struts 22. But this advantage has to be paid for by the disadvantage of greater mass of the optical unit. The receiving structure 12 of this optical unit is also open.

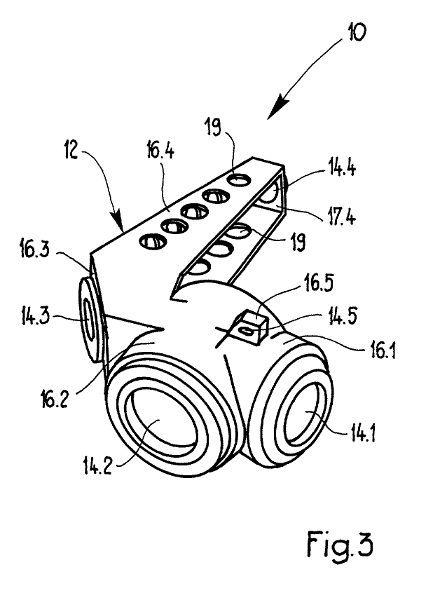

FIG. 3 shows a still further optical unit 10, again with the same optical elements 14.1 to 14.5. The receiving structure 12 of this optical unit 10 is complex, i.e. on the one hand it comprises support elements such as the open receiving structures in the form of linear supports or plates or shells, and on the other hand support elements in the form of tubes. The element supports 16.3 and 16.5 are designed essentially the same as in the optical units represented in FIGS. 1 and 2. Except for a transverse element 17.4, the element support 16.4 consists essentially of three linear supports, which are put together in such a way that they form a U-shaped channel, which is open in the linear direction of the element support. Here, the element supports 14.1 and 14.2 are embodied to be closed, namely in the form of tubes.

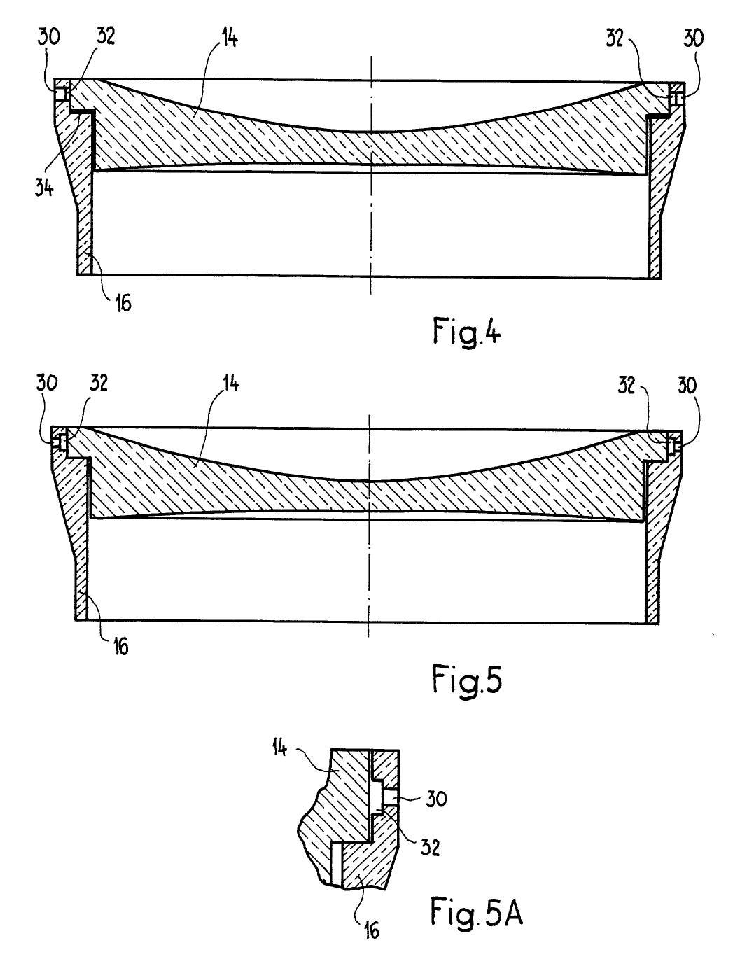

An optical element 14 fastened in an element support 16 is represented in each one of FIGS. 4 and 5. The element support 16 preferably consists of two half shells. The optical element 14 and the element support 16 are made of the same glass-ceramic material. The element support 16 has at least one injection bore 30, however, at least two injection bores are advantageously provided. The inner end of these injection bores terminates in a circumferential groove 32, so that an annularly circulating hollow space between the element support 16 and the optical element 14 is formed by this. A suitable adhesive, or cement, is pressed into the circumferential groove 32 through at least one of the injection bores 30 until the entire circumferential groove 32 has been filled.

FIG. 4 shows an exemplary embodiment wherein the exact arrangement of the optical element 14 has been achieved by the insertion of spacers 34, so-called shims.

FIG. 5 shows an exemplary embodiment wherein the optical element 14 rests directly on a shoulder of the element support 16, wherein in accordance with FIG. 5A centering is provided.

What is claimed is:

1. An optical unit comprising a plurality of optical elements, a receiving structure with a plurality of element supports for receiving said optical elements
wherein each of said element supports is in the form of a plate or shell, whose dimensions are greater than the dimensions of the optical elements to be received, and is connected on at least one edge to another element support.

2. The optical unit in accordance with claim 1, further comprising struts for connecting one or more element supports to each other.

3. The optical unit in accordance with claim 1, wherein said receiving structure is molded or worked out of a block as an integral piece.

4. The optical unit in accordance with claim 1, wherein the element supports and the optical elements are produced from materials with at least approximately the same coefficients of heat expansion and/or rigidity properties.

5. An optical unit comprising at least one optical element and an integrally produced element support, in which each optical element is fastened within an
element support and all optical elements are made of the same material.

6. The optical unit in accordance with claim 5, wherein the material used to produce the optical elements is a glass-ceramic material.

7. The optical unit in accordance with claim 1, wherein at least one optical element is fastened directly in the associated element support by cementing or gluing.

8. The optical unit in accordance with claim 7, wherein on the element support part which touches the optical element, the element support has at least one injection bore, and that a hollow space, which circles around it, is formed on a contact surface between the element support and the optical element.

9. The optical unit in accordance with claim 1, wherein the optical elements are positioned in the element supports by means of cooperating fitting surfaces and/or by spacers arranged between the optical elements and the element supports.

10. Use of the optical unit in accordance with claim 1, wherein
the receiving structure is fastened at least approximately isostatically on the apparatus.

11. The use in accordance with claim 10, wherein a removable protective device for the optical elements is provided for protecting them during transport into space.
